(19) United States
(12) Patent Application Publication
(10) Pub. No.: US 2025/0126217 A1
(43) Pub. Date: Apr. 17, 2025

(54) IMAGE FORMING DEVICE

(71) Applicant: SHARP KABUSHIKI KAISHA, Sakai City (JP)

(72) Inventor: Yasumasa Morimoto, Sakai City (JP)

(21) Appl. No.: 18/910,252

(22) Filed: Oct. 9, 2024

(30) Foreign Application Priority Data
Oct. 17, 2023 (JP) 2023-178699

(51) Int. Cl. H04N 1/00

(52) U.S. Cl. CPC H04N 1/00755; H04N 1/00689; H04N 1/00694

(57) ABSTRACT

When a light blocking body is located at a light blocking position where light emitted from a light emitter toward a light receiver of a document detection sensor is blocked, the document detection sensor is set to be in a light blocking state in which the emitted light is blocked. When the light blocking body is located at a light receiving position to make it possible for the light emitted from the light emitter toward the light receiver of the document detection sensor to be received, the document detection sensor is set to be in a light receiving state in which the emitted light is received. A controller judges that, when the document detection sensor is in the light receiving state, an access cover is opened or the access cover is closed and a document is not placed on a document tray, and judges that, when the document detection sensor is in the light blocking state, the access cover is closed and the document is placed on the document tray.

### CROSS-REFERENCE TO RELATED APPLICATION

The present application claims priority from Japanese Application JP 2023-178699, the content to which is hereby incorporated by reference into this application.

### BACKGROUND OF THE INVENTION

### 1. Field of the Invention

The present disclosure relates to an image forming device provided with: a document feeder including a document tray on which a document is placed, a document placement detector that detects the document placed on the document tray, and a pickup unit equipped with a pickup roller that feeds the document placed on the document tray to a downstream side of a document conveyance path; and a controller that controls the document feeder.

### 2. Description of the Related Art

In an image forming device of the related art, it is known that an access detection scheme and a document placement detection scheme are provided in the device main body, and a portion to be detected is provided on an upper cover.

In the image forming device of the related art, when both the access detection scheme and the document placement detection scheme are turned “ON”, it is understood that the upper cover is closed and no jam has occurred.

### SUMMARY OF THE INVENTION

The image forming device of the related art includes a dedicated access detection scheme to detect an access state of the upper cover (equivalent to an access cover of the present application), and therefore costs of the access detection scheme and a space to be provided with the access detection scheme are required.

The present disclosure has been conceived in view of the above-described problems, and an object of the present disclosure is to provide an image forming device that can omit a dedicated access detection scheme for detecting an access state of an access cover as in the image forming device of the related art, and can exhibit advantageous effects in terms of the cost and space.

In order to accomplish the above object, an image forming device according to an aspect of the present disclosure is provided with: a document feeder including a document tray on which a document is placed, a document placement detector that detects the document placed on the document tray, and a pickup unit equipped with a pickup roller that feeds the document placed on the document tray to a downstream side of a document conveyance path; and at least one controller that controls the document feeder. The document placement detector includes a document detection lever that is provided on an access cover provided in an openable and closable manner above the document tray, is located at a detection standby position for the document when the document is not placed on the document tray, and is displaced to a detection position for the document by being brought into contact with the document when the document is placed on the document tray; and a document detection sensor that is provided in a main body of the document feeder and includes a light emitter and a light receiver. The document detection lever is provided with a light blocking body to be displaced to a light blocking position where light emitted from the light emitter toward the light receiver of the document detection sensor is blocked or displaced to a light receiving position to make it possible for the emitted light to be received while interlocking with the displacement of the document detection lever. The document detection sensor is set to be in a light blocking state in which the emitted light is blocked when the light blocking body is located at the light blocking position, and in a light receiving state in which the emitted light is received when the light blocking body is located at the light receiving position. The controller judges that, when the document detection sensor is in the light receiving state, the access cover is opened or the access cover is closed and the document is not placed on the document tray, and judges that, when the document detection sensor is in the light blocking state, the access cover is closed and the document is placed on the document tray.

According to the above-described configuration, since the controller can judge the state of the document feeder based on a signal from the document detection sensor, it is possible to omit a dedicated access detection scheme for detecting the access state of the access cover as in the image forming device of the related art. Therefore, an image forming device exhibiting advantageous effects in terms of the cost and space can be provided.

The image forming device according to the aspect of the present disclosure may further include a jam detection sensor that detects a jam of the document conveyed on the document conveyance path, and an operation inputter. Further, in a case where the operation inputter is operated after the jam detection sensor is switched from a jam detection state in which a jam of the document is detected to a non-jam detection state in which no jam is detected, the controller may switch the image forming device from the jam detection state to a job restart state.

The image forming device according to the aspect of the present disclosure may further include a display, wherein the controller may switch the image forming device from the jam detection state to the job restart state, and may switch a display content of the display from a screen indicating the jam detection state to a screen indicating the job restart state.

In the image forming device according to the aspect of the present disclosure, the controller may switch the image forming device from the jam detection state to the job restart state, and may cause the pickup unit to execute an initial operation.

In order to accomplish the above object, an image forming device according to an aspect of the present disclosure is provided with: a document feeder including a document tray on which a document is placed, a document placement detector that detects the document placed on the document tray, and a pickup unit equipped with a pickup roller that feeds the document placed on the document tray to a downstream side of a document conveyance path; and at least one controller that controls the document feeder. The document placement detector includes a document detection lever that is provided on an access cover provided in an openable and closable manner above the document tray, is located at a detection standby position for the document when the document is not placed on the document tray, and is displaced to a detection position for the document by being brought into contact with the document when the document is placed on the document tray; and a document detection sensor that is provided in a main body of the document feeder and includes a light emitter and a light receiver. The document detection lever is provided with a light blocking body to be displaced to a light blocking position where light emitted from the light emitter toward the light receiver of the document detection sensor is blocked or displaced to a light receiving position to make it possible for the emitted light to be received while interlocking with the displacement of the document detection lever. The document detection sensor is set to be in a light blocking state in which the emitted light is blocked when the light blocking body is located at the light blocking position, and in a light receiving state in which the emitted light is received when the light blocking body is located at the light receiving position. The controller judges that, when the document detection sensor is in the light blocking state, the access cover is closed and the document is not placed on the document tray, and judges that, when the document detection sensor is in the light receiving state, the access cover is opened or the access cover is closed and the document is placed on the document tray.

According to the above-described configuration, since the controller can judge the state of the document feeder based on a signal from the document detection sensor, it is possible to omit a dedicated access detection scheme for detecting the access state of the access cover as in the image forming device of the related art. Therefore, an image forming device exhibiting advantageous effects in terms of the cost and space can be provided.

The image forming device according to the aspect of the present disclosure may further include a jam detection sensor that detects a jam of the document conveyed on the document conveyance path. Further, under a condition that in a case where the jam detection sensor is switched from a jam detection state in which a jam of the document is detected to a non-jam detection state in which no jam is detected, and it is judged that the document is not placed on the document tray when the access cover is closed, the controller may switch the image forming device from the jam detection state to a job restart state.

The image forming device according to the aspect of the present disclosure may further include a display, wherein the controller may switch the image forming device from the jam detection state to the job restart state, and may switch a display content of the display from a screen indicating the jam detection state to a screen indicating the job restart state.

In the image forming device according to the aspect of the present disclosure, the controller may switch the image forming device from the jam detection state to the job restart state, and may cause the pickup unit to execute an initial operation.

In order to accomplish the above object, an image forming device according to an aspect of the present disclosure is provided with: a document feeder including a document tray on which a document is set, a document placement detector that detects the document placed on the document tray, and a pickup unit equipped with a pickup roller that feeds the document placed on the document tray to a downstream side of a document conveyance path; and at least one controller that controls the document feeder. The image forming device further includes a jam detection sensor to detect a jam of the document conveyed on the document conveyance path. The document placement detector includes a document detection lever that is provided on an access cover provided in an openable and closable manner above the document tray, is located at a detection standby position for the document when the document is not placed on the document tray, and is displaced to a detection position for the document by being brought into contact with the document when the document is placed on the document tray; and a document detection sensor that is provided in a main body of the document feeder and includes a light emitter and a light receiver. The document detection lever is provided with a light blocking body to be displaced to a light blocking position where light emitted from the light emitter toward the light receiver of the document detection sensor is blocked or displaced to a light receiving position to make it possible for the emitted light to be received while interlocking with the displacement of the document detection lever. The document detection sensor is set to be in a light blocking state in which the emitted light is blocked when the light blocking body is located at the light blocking position, and in a light receiving state in which the emitted light is received when the light blocking body is located at the light receiving position. The controller judges that, when the document detection sensor is in the light receiving state, the access cover is opened or the access cover is closed and the document is not placed on the document tray, and judges that, when the document detection sensor is in the light blocking state, the access cover is closed and the document is placed on the document tray. In addition, after the jam detection sensor is switched from a jam detection state in which a jam of the document is detected to a non-jam detection state in which no jam is detected, in a case where the document detection sensor is switched from the light receiving state to the light receiving state via the light blocking state, the controller switches the image forming device from the jam detection state to a job restart state.

According to the above-described configuration, since the controller can judge the state of the document feeder based on signals from the document detection sensor and the jam detection sensor, it is possible to omit a dedicated access detection scheme for detecting the access state of the access cover as in the image forming device of the related art. Therefore, an image forming device exhibiting advantageous effects in terms of the cost and space can be provided.

The image forming device according to the aspect of the present disclosure may further include a display, wherein the controller may switch the image forming device from the jam detection state to the job restart state, and may switch a display content of the display from a screen indicating the jam detection state to a screen indicating the job restart state.

In the image forming device according to the aspect of the present disclosure, the controller may switch the image forming device from the jam detection state to the job restart state, and may cause the pickup unit to execute an initial operation.

### BRIEF DESCRIPTION OF THE DRAWINGS

FIG. 1 is a perspective view illustrating an external appearance of an image forming device.

FIG. 2 is a front view illustrating a schematic configuration of an image forming device in a see-through manner.

FIG. 3 is an explanatory diagram illustrating an outline of a document feeder.

FIG. 4 is an explanatory diagram illustrating an outline of a document feeder.

FIG. 5A is a top view of a document detection member.

FIG. 5B is a left side view of a document detection member.

FIG. 5C is a front view of a document detection member.

FIG. 5D is a right side view of a document detection member.

FIG. 5E is a bottom view of a document detection member.

FIG. 5F is a rear view of a document detection member.

FIG. 6A is a top view of a detection body.

FIG. 6B is a left side view of a detection body.

FIG. 6C is a front view of a detection body.

FIG. 6D is a right side view of a detection body.

FIG. 6E is a bottom view of a detection body.

FIG. 6F is a rear view of a detection body.

FIG. 7 is an explanatory diagram illustrating a hardware configuration of an image forming device.

FIG. 8 is an explanatory diagram illustrating a document feeder in a state where an access cover is opened.

FIG. 9 is an explanatory diagram illustrating a document feeder in a state where an access cover is closed.

FIG. 10 is an explanatory diagram illustrating a document feeder in which a document is set.

FIG. 11 is an explanatory diagram illustrating a document feeder in a state where an access cover is opened in an image forming device according to a first embodiment.

FIG. 12 is an explanatory diagram illustrating a document feeder in a state where an access cover is closed in an image forming device according to the first embodiment.

FIG. 13 is an explanatory diagram illustrating a document feeder in which a document is placed in an image forming device according to the first embodiment.

FIG. 14 is an explanatory diagram illustrating a document feeder in a state where an access cover is opened in an image forming device according to a second embodiment.

FIG. 15 is an explanatory diagram illustrating a document feeder in a state where an access cover is closed in an image forming device according to the second embodiment.

FIG. 16 is an explanatory diagram illustrating a document feeder in which a document is placed in an image forming device according to the second embodiment.

FIG. 17 is an explanatory diagram illustrating a document feeder in a state where an access cover is opened in an image forming device according to a third embodiment.

FIG. 18 is an explanatory diagram illustrating a document feeder in a state where an access cover is closed in an image forming device according to the third embodiment.

FIG. 19 is an explanatory diagram illustrating a document feeder in which a document is placed in an image forming device according to the third embodiment.

FIG. 20 is an explanatory diagram of contents displayed on a display when a jam occurs.

FIG. 21 is an explanatory diagram of contents displayed on a display after a jam is resolved.

### DETAILED DESCRIPTION OF THE INVENTION

### First Embodiment

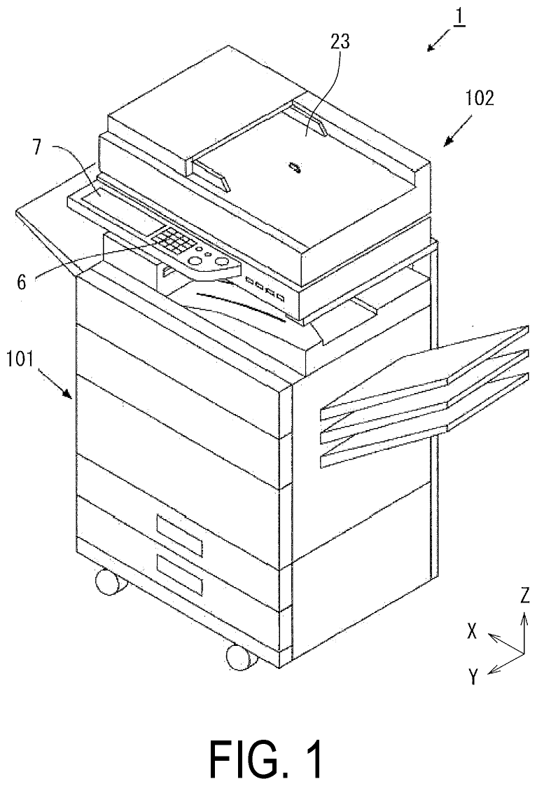

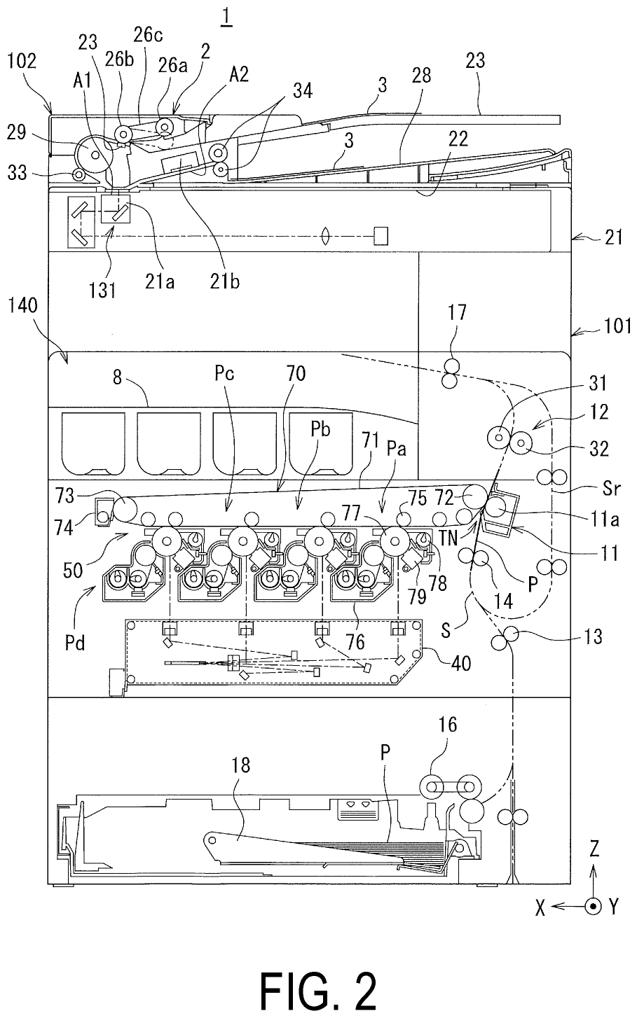

An image forming device 1 according to a first embodiment of the present disclosure will be described below with reference to the accompanying drawings. FIG. 1 is a perspective view illustrating an external appearance of the image forming device 1 according to the first embodiment of the present disclosure, and FIG. 2 is a front view illustrating a schematic configuration of the image forming device 1 in a see-through manner. In the coordinates depicted in FIGS. 1 and 2, an X-axis direction indicates a left-right direction (lateral direction) when the image forming device 1 is viewed from the front, and an X-axis positive direction and an X-axis negative direction indicate a left side and a right side, respectively. A Y-axis direction indicates a depth direction (front-rear direction) orthogonal to the X-axis extending in the left-right direction, and a Y-axis positive direction and a Y-axis negative direction indicate an operation side (front side) and a rear side opposite to the operation side, respectively. A Z-axis direction represents an up-down direction, that is, a vertical direction, and a Z-axis positive direction and a Z-axis negative direction represent an upper side and a lower side, respectively. FIG. 1 and FIG. 2 are each an example given for explaining a general configuration of the image forming device 1, and the image forming device 1 illustrated in FIG. 1 and the image forming device 1 illustrated in FIG. 2 are not the same device.

The image forming device 1 is a multi-functional device having a copy function, a facsimile function and a printer function, and including an image reading device 102 and an image forming device body 101. For example, the image forming device 1 can execute a copy job by executing the copy function.

The copy job will be briefly described below. First, a document is placed in the image reading device 102, and a copy operation is designated on an operation inputter 6. The operation inputter 6 is provided with a display 7, and a user can confirm the set document size, sheet size, and copy setting (e.g., single-sided, double-sided, or 2 in 1 setting) on the display 7.

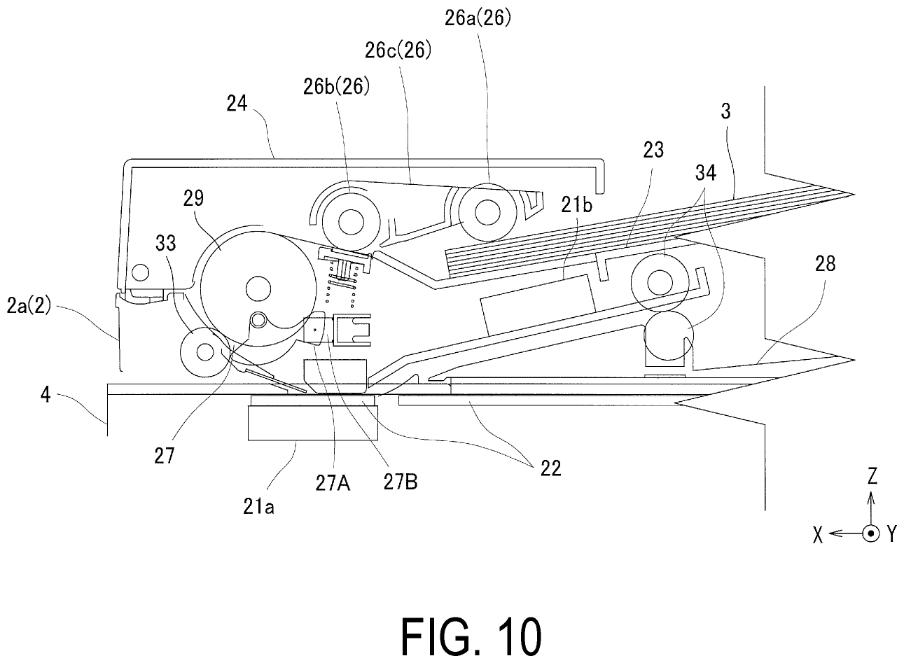

When the user performs a copy start operation from the operation inputter 6, a copy process is executed. Specifically, the image reading device 102 reads a document 3 placed on a document tray 23, and image data is generated from the document 3 read by the image reading device 102 (see FIG. 10).

The image forming device body 101 generates an image based on the image data read by the image reading device 102 on a sheet P fed from a sheet cassette 18, and outputs the sheet P with the image formed thereon from a discharge tray 8. In the present embodiment, the sheet is recording paper or a recording sheet on which an image is formed. Examples of the sheet include, in addition to ordinary plain paper, various paper media such as thick paper and glossy paper, and a film as long as an image can be formed thereon.

The image forming device body 101 will be described first. The image forming device body 101 includes an image transferrer 50, an optical scanner 40, an intermediate transfer belt device 70, a secondary transfer device 11, a fixing device 12, a sheet conveyance path S, the sheet cassette 18, and the discharge tray 8.

The image forming device body 101 deals with image data corresponding to a color image using colors of black (K), cyan (C), magenta (M) and yellow (Y), or image data corresponding a monochrome image using a single color (e.g., black).

The image transferrer 50 of the image forming device 1 includes four image stations Pa, Pb, Pc, and Pd corresponding to individual colors of black, cyan, magenta, and yellow. Each of the image stations Pa, Pb, Pc, and Pd includes a developer 76, a photoreceptor drum 77, a drum cleaner 78, and a charger 79, whereby four types of toner images are formed by the image stations Pa, Pb, Pc, and Pd. That is, the image forming device 1 is provided with four sets of the developer 76, photoreceptor drum 77, drum cleaner 78, and charger 79, and these sets respectively correspond to black, cyan, magenta, and yellow.

The optical scanner 40 exposes the surface of the photoreceptor drum 77 to form an electrostatic latent image. The developer 76 develops the electrostatic latent image on the surface of the photoreceptor drum 77 to form a toner image on the surface of the photoreceptor drum 77. The drum cleaner 78 removes and collects residual toner on the surface of the photoreceptor drum 77. The charger 79 uniformly charges the surface of the photoreceptor drum 77 to a predetermined potential. With the above-discussed series of operations, a toner image of each color is formed on the surface of each photoreceptor drum 77.

The intermediate transfer belt device 70 includes an intermediate transfer roller 75, an intermediate transfer belt 71 having an endless shape, an intermediate transfer driving roller 72, an intermediate transfer driven roller 73, and a cleaner 74. The intermediate transfer belt 71 is an endless belt capable of moving in a circumvolution manner, and is wound around the intermediate transfer driving roller 72 and the intermediate transfer driven roller 73. That is, the intermediate transfer belt 71 is stretched over the intermediate transfer driving roller 72 and the intermediate transfer driven roller 73. Four of the intermediate transfer rollers 75 are provided on an inner side of the intermediate transfer belt 71 to form four types of toner images corresponding to the individual colors. The intermediate transfer roller 75 transfers the toner image of each color formed on the surface of the photoreceptor drum 77 onto the intermediate transfer belt 71.

In the image forming device 1, the toner images of the individual colors formed on the surfaces of the respective photoreceptor drums 77 are sequentially transferred and superimposed to form a color toner image on the surface of the intermediate transfer belt 71 stretched over the intermediate transfer driving roller 72 and the intermediate transfer driven roller 73. The toner image formed on the intermediate transfer belt 71 is transferred onto the sheet P in the secondary transfer device 11. Part of the toner image formed on the intermediate transfer belt 71 is not transferred onto the sheet P and remains on the surface of the intermediate transfer belt 71 as waste toner. The waste toner is removed and collected by the cleaner 74.

The secondary transfer device 11 forms a transfer nip region TN between a secondary transfer roller 11a and the intermediate transfer belt 71, and conveys the sheet P having been conveyed through the sheet conveyance path S while nipping the sheet P in the transfer nip region TN. When the sheet P passes through the transfer nip region TN, the toner image on the surface of the intermediate transfer belt 71 is transferred onto the sheet P, and the sheet P is conveyed to the fixing device 12.

The fixing device 12 includes a fixing roller 31 and a pressure roller 32, which nip the sheet P and rotate. In the fixing device 12, the sheet P with the transferred toner image is nipped between the fixing roller 31 and the pressure roller 32, and is subjected to heating and pressure to fix the toner image onto the sheet P. Although not illustrated, a heater as a heat source is disposed inside the fixing roller 31, whereby the surface of the fixing roller 31 in contact with the sheet P, on which the toner image has been transferred, is heated by the heat generated by the heater.

The sheet cassette 18 is a cassette for storing the sheets P to be used for image formation, and is provided under the optical scanner 40. The sheet P is pulled out from the sheet cassette 18 by a pickup roller 16 and conveyed to the sheet conveyance path S. The sheet P having been conveyed to the sheet conveyance path S is conveyed to discharge rollers 17 via the secondary transfer device 11, the fixing device 12 and the like, and is discharged to the discharge tray 8 in a sheet discharger 140. Conveying rollers 13, registration rollers 14, and the discharge rollers 17 are disposed along the sheet conveyance path S. The conveying rollers 13 facilitate the conveyance of the sheet P. The registration rollers 14 temporarily stop the sheet P and align a leading end of the sheet P. Further, the registration rollers 14 convey the temporarily stopped sheet P in synchronization with the timing of a color toner image on the intermediate transfer belt 71. The color toner image on the intermediate transfer belt 71 is transferred onto the sheet P in the transfer nip region TN between the intermediate transfer belt 71 and the secondary transfer roller 11a.

FIG. 2 illustrates a configuration in which one sheet cassette 18 is provided, but no such limitation is intended. A configuration having a plurality of the sheet cassettes 18 may be employed, and different types of sheets P may be respectively stacked in the plurality of sheet cassettes 18.

In a case where the image forming device 1 forms an image not only on the surface but also on the rear surface of the sheet P, the sheet P is conveyed in the reverse direction from the discharge rollers 17 to a sheet reverse path Sr. The image forming device 1 reverses the front and rear of the sheet P having been conveyed in the reverse direction and guides the sheet P again to the registration rollers 14. The image forming device 1 forms an image on the rear surface of the sheet P guided to the registration rollers 14 similar to the case of forming an image on the surface of the sheet P, and conveys the sheet P to the discharge tray 8.

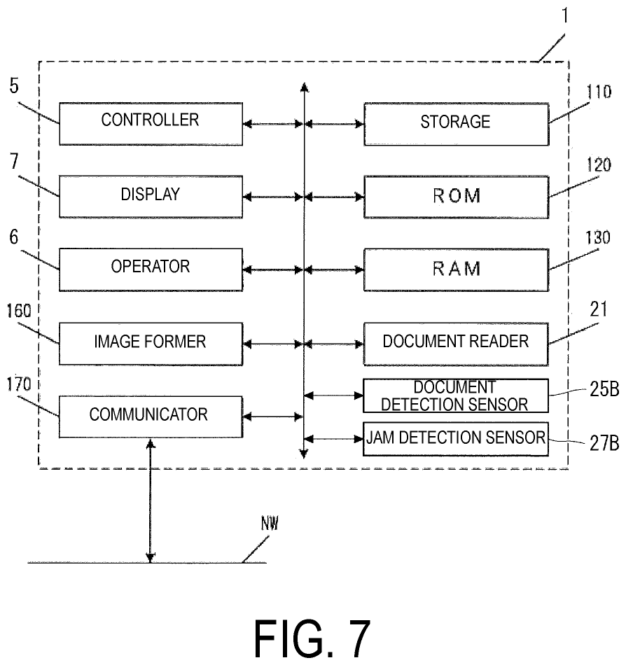

As illustrated in FIG. 7, the image forming device 1 includes a controller 5, a storage 110 as a storage device, a ROM 120 and a RAM 130, the operation inputter 6 (see FIG. 1), the display 7 (see FIG. 1), an image former 160, a document reader 21, and a communicator 170.

The controller 5 controls the entirety of the image forming device 1. The controller 5 enables various functions by reading out and executing various programs stored in one or multiple storage devices (e.g., the storage 110 and the ROM 120). The controller 5 may be implemented by one or multiple control devices/arithmetic devices (central processing units (CPUs)), or a system on a chip (SoC). The controller 5 may be configured of a control circuit.

The storage 110 is a non-volatile storage device capable of storing programs and data. For example, the storage 110 may be configured of a storage device such as a hard disk drive (HDD) or a solid state drive (SSD). The storage 110 may be configured as a USB memory that can be connected to an external device. The storage 110 may be, for example, a storage area on a cloud.

The ROM 120 is a non-volatile memory capable of holding the program and data even in a case that the power is turned off.

The RAM 130 is a main memory mainly used when the controller 5 executes processing. The RAM 130 is a rewritable memory that temporarily holds a program read from the storage 110 or the ROM 120 and data including an execution result.

The operation inputter 6 is an operation device that allows a user to input an operation. For example, the operator 6 may be an operation device such as a touch panel integrated with the display 7 or an operation button. The operation inputter 6 may be an operation device such as a keyboard or a mouse. The operation inputter 6 may include an interface (e.g., a universal serial bus (USB)) to which an operation device can be connected.

For example, a different operation device (an operation device including a touch panel) may be connected to the image forming device 1.

The display 7 is a display device that can display various types of information, an execution screen, and the like. The display 7 may be, for example, a display device such as a liquid crystal display (LCD), an organic electro-luminescence (EL) display, or an electrophoresis display. The display 7 includes an interface to which a display device can be connected. For example, the display 7 may be configured of an external display device connected via high-definition multimedia interface (HDMI) (trade name), digital visual interface (DVI), or DisplayPort.

The display 7 may have an optional size. In recent years, for the purpose of improving operability, a large-sized operation panel of 8 inches or 10 inches, for example, has been frequently used for the display 7.

As described below, the document reader 21 reads an image on the document 3 and outputs the read image as image data. The document reader 21 may be, for example, a scanner, which is a reading device utilizing a charge coupled device (CCD), a contact image sensor (CIS), or the like.

The communicator 170 is a communication interface that communicates with other devices. The communicator 170 may be, for example, a network interface capable of providing wired connection or wireless connection. In the present embodiment, communication with other devices is available via a network NW.

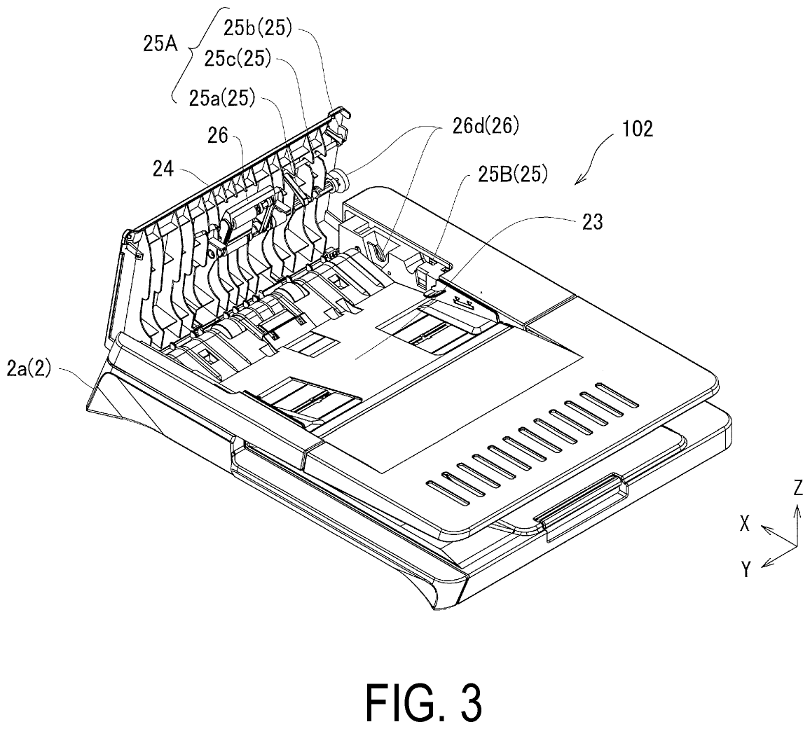

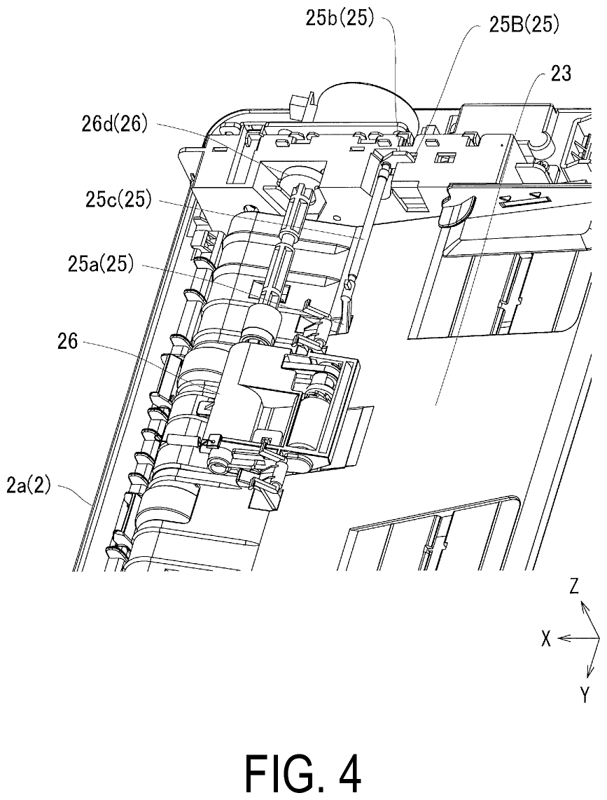

Next, the image reading device 102 will be described. As illustrated in FIGS. 2, 3, and 4, the image reading device 102 includes the document reader 21 and a document feeder 2 (automatic document feeding device (ADF)). The document feeder 2 is provided at the upper side of the document reader 21, and is supported in an openable and closable manner with respect to the document reader 21. In the coordinates depicted in FIGS. 3 and 4, the X-axis direction indicates the left-right direction (lateral direction) when the document feeder 2 is viewed from the front, and the X-axis positive direction and the X-axis negative direction indicate the left side and the right side, respectively. The document feeder 2 conveys a document along the X-axis direction. That is, the X-axis direction is a direction along the document conveyance direction. The Y-axis direction indicates the depth direction (front-rear direction) orthogonal to the X-axis extending in the left-right direction, and the Y-axis positive direction and the Y-axis negative direction indicate the operation side (front side) and the rear side opposite to the operation side, respectively. The Y-axis direction is a direction orthogonal to the document conveyance direction. The Z-axis direction represents the up-down direction, that is, the vertical direction, and the Z-axis positive direction and the Z-axis negative direction represent the upper side and the lower side, respectively.

The document feeder 2 conveys the document 3 of one or multiple sheets one by one. The image reading device 102 reads the document 3 conveyed by the document feeder 2 one by one among the document 3 of one or multiple sheets.

The document reader 21 includes a document table 22, on which the document 3 is set, and a scanning optical system 131 including a first document reader 21a. The scanning optical system 131 reads the document 3.

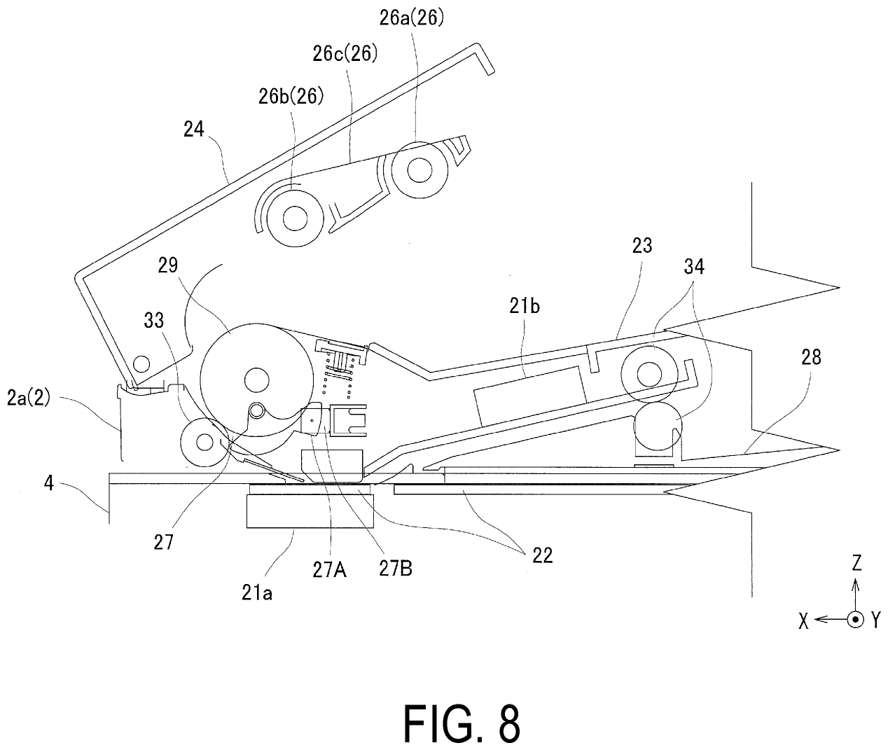

The image reading device 102 has a placed document reading function to read the document 3 placed on the document table 22. In the image forming device 1, when the document feeder 2 is opened, the document table 22 above the document reader 21 (for example, see FIGS. 8 to 19) is exposed, so that the document 3 can be manually placed on the document table 22. The document reader 21 reads the document that is placed on the document table 22 by scanning operation of the scanning optical system 131. In the coordinates depicted in FIGS. 8 to 19, the X-axis direction indicates the left-right direction (lateral direction) when the document feeder 2 is viewed from the front, and the X-axis positive direction and the X-axis negative direction indicate the left side and the right side, respectively. The document feeder 2 conveys a document along the X-axis direction. That is, the X-axis direction is a direction along the document conveyance direction. The Y-axis direction indicates the depth direction (front-rear direction) orthogonal to the X-axis extending in the left-right direction, and the Y-axis positive direction and the Y-axis negative direction indicate the operation side (front side) and the rear side opposite to the operation side, respectively. The Y-axis direction is a direction orthogonal to the document conveyance direction. The Z-axis direction represents the up-down direction, that is, the vertical direction, and the Z-axis positive direction and the Z-axis negative direction represent the upper side and the lower side, respectively.

The document feeder 2 includes a document tray 23 to stack the document 3 thereon, and a pickup unit 26 for picking up the document 3 stacked on the document tray 23 one sheet by one sheet. In the pickup unit 26, a pickup roller 26a and a feed roller 26b are provided in a roller holder 26c, where the feed roller 26b conveys the document 3 pulled out by the pickup roller 26a.

The document feeder 2 further includes a large-diameter conveying roller 29 for conveying the document 3 conveyed by the feed roller 26b, a driven roller 33 disposed to be opposed and pressed against the large-diameter conveying roller 29, a second document reader 21b for reading the rear surface (the other surface) side of the conveyed document 3, and a pair of document discharge rollers 34 for discharging the read document 3 to a document discharge tray 28.

The document feeder 2 includes a document conveyance path 27, on which the document 3 is conveyed, and part of the document conveyance path 27 is curved in a U shape. In the document conveyance path 27, there are present a first document reading position A1, at which the surface (one surface) side of the document 3 is read by the first document reader 21a, and a second document reading position A2, at which the rear surface side of the document 3 is read by the second document reader 21b.

The document reader 21 (see FIG. 2) is configured of a so-called CIS scanner in which LEDs of three colors of RGB whose light emissions are controlled by the controller 5 are used as a light source, the light emitted from the light source is hit on the document 3 over the document table 22, and the light reflected from the document 3 is read by the image sensor via a lens array. However, the document reader 21 may be configured of a CCD scanner.

As illustrated in FIGS. 8 to 10, the document feeder 2 includes the document tray 23, on which the document 3 is placed, an access cover 24 provided in an openable and closable manner above the document tray 23, a document placement detector 25 to detect the document 3 placed on the document tray 23, the pickup unit 26 to feed the document 3 placed on the document tray 23 to the document reader 21 for reading the content of the document 3, a detection body 27A movable by the document 3 conveyed on the document conveyance path 27 in the document feeder 2, a jam detection sensor 27B for detecting a jam of the document 3 based on the movement of the detection body 27A, the document discharge tray 28 for discharging the read document 3 thereon and the like.

The jam means a situation in which the document 3 jams in the document conveyance path 27 and the operation is interrupted. When the jam occurs, since normal reading of the document 3 cannot be continued, it is necessary to open the access cover 24 and remove the jamming document 3.

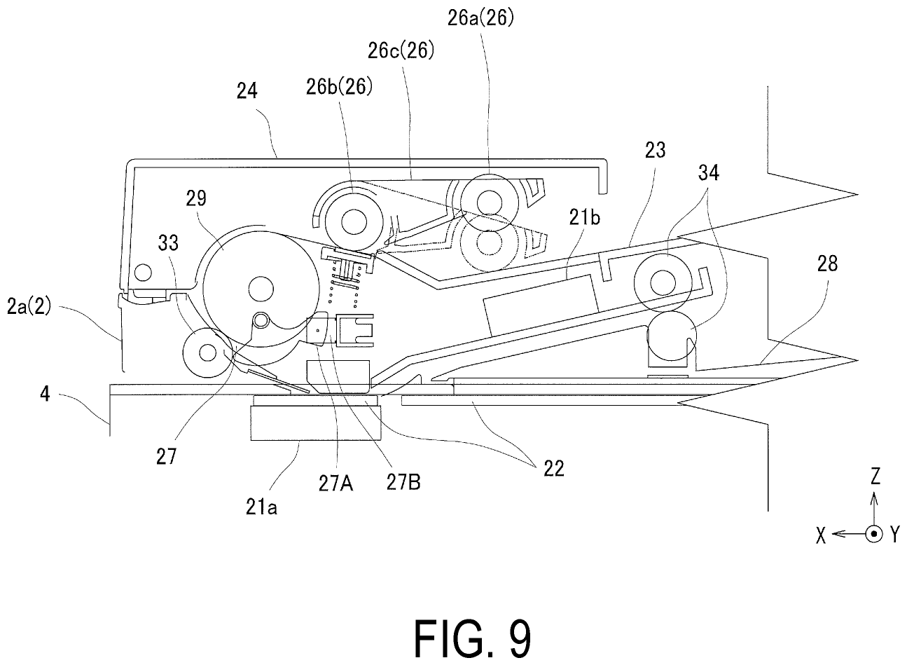

As illustrated in FIGS. 9 to 11, the document placement detector 25 includes a document detection member 25A rotatably provided on the lower surface of the access cover 24, and a document detection sensor 25B provided in a document feeder body 2a of the document feeder 2.

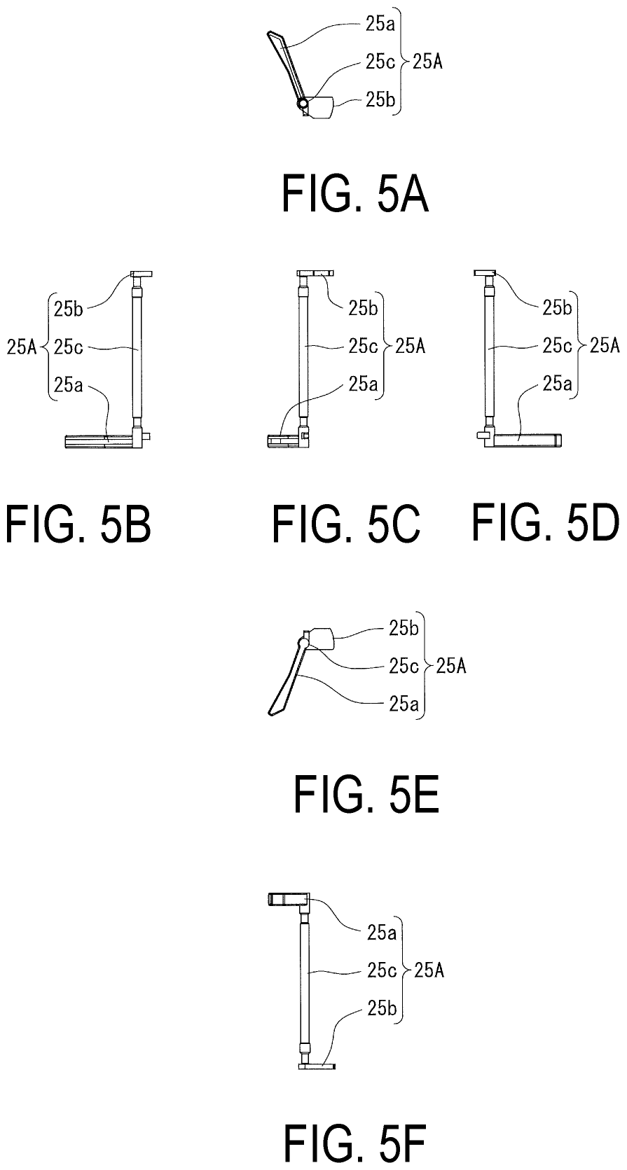

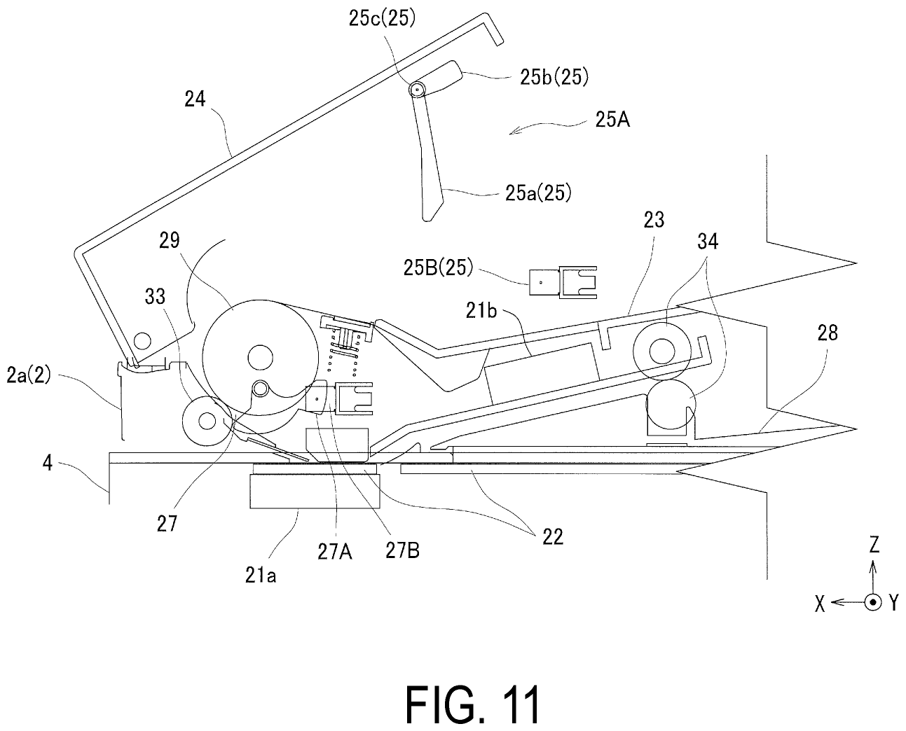

As illustrated in FIG. 5A, FIG. 5B, FIG. 5C, FIG. 5D, FIG. 5E, and FIG. 5F, the document detection member 25A is provided with a document detection lever 25a, a light blocking body 25b, and a rotation shaft 25c connecting the document detection lever and the light blocking body in such a manner that these components are integrally formed. As illustrated in FIGS. 11, 12, and 13, the document detection member 25A is supported to be rotatable about the rotation shaft 25c.

As illustrated in FIGS. 3 and 4, the document detection member 25A is disposed along the Y-axis direction (a direction orthogonal to the document conveyance direction). The document detection lever 25a is disposed in the main body of the document feeder 2 while being located within the width region of the document 3 to be in contact with the document 3. On the other hand, a light blocking body 25b and the document detection sensor 25B are disposed in the main body of the document feeder 2 while being located outside the width region of the document 3 not to be brought into contact with the document 3.

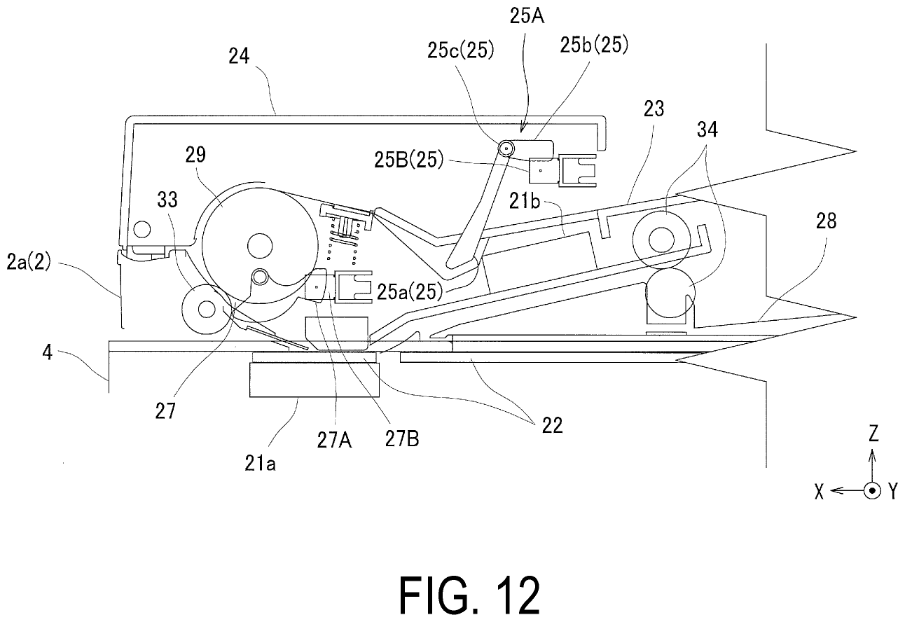

When the access cover 24 is opened, the document detection member 25A is rotated by the own weight of the document detection member 25A, and the document detection lever 25a and the light blocking body 25b are positioned as depicted in FIG. 11. On the other hand, when the access cover 24 is closed, the document detection member 25A is rotated by the own weight of the document detection member 25A, and the document detection lever 25a and the light blocking body 25b are positioned as depicted in FIG. 12.

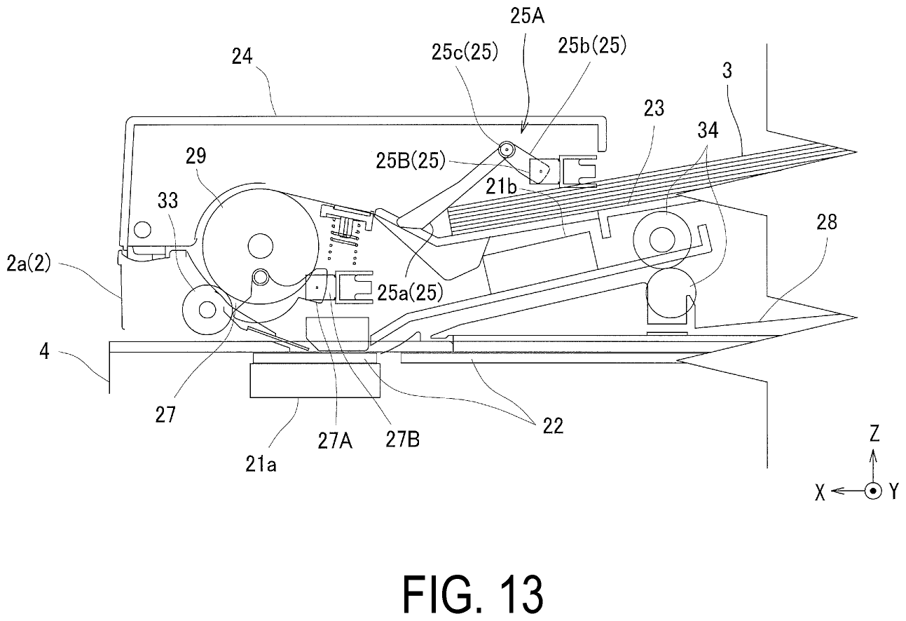

When the document 3 is placed on the document tray 23, the document detection member 25A is rotated by the contact with the document 3, and the document detection lever 25a and the light blocking body 25b are positioned as depicted in FIG. 13.

The document detection sensor 25B is constituted of a transmission type photoelectric sensor including a light emitter that emits light in a straight line and a light receiver that receives the light emitted from the light emitter.

When the emitted light is blocked or received depending on presence or absence of the light blocking body 25b between the light emitter and light receiver and the quantity of light received by the light receiver is changed, electric characteristics of a photoelectric conversion element incorporated in the light receiver are changed. Then, the change of the electric characteristics is detected and amplified to output an object detection signal to the controller 5.

The light blocking body 25b is displaced to a light blocking position where light emitted from the light emitter toward the light receiver of the document detection sensor 25B is blocked or to a light receiving position to make the emitted light received without being blocked in response to whether or not the document 3 is set, that is, interlocking with the displacement of the document detection lever 25a.

In the present embodiment, in a case where the access cover 24 is closed, the light blocking body 25b is located at the light receiving position when the document detection lever 25a is located at a detection standby position (see FIG. 12), and the light blocking body 25b is located at the light blocking position when the document detection lever 25a is located at a detection position (see FIG. 13).

Therefore, the document detection sensor 25B is in a light receiving state in which the emitted light is received when the light blocking body 25b is at the light receiving position, and is in a light blocking state in which the emitted light is blocked when the light blocking body 25b is at the light blocking position.

That is, when the document 3 is not set, the document detection lever 25a is located at the detection standby position (see FIG. 12) because there is no document 3 in contact with the document detection lever 25a. At this time, since the light blocking body 25b is located at the light receiving position to make it possible for the light emitted from the light emitter to be received by the light receiver in the document detection sensor 25B, the document detection sensor 25B is in the light receiving state.

When the document 3 is set, the document 3 is brought into contact with the document detection lever 25a, and thus the document detection lever 25a is located at the detection position (see FIG. 13). At this time, since the light blocking body 25b is located at the light blocking position where the light emitted from the light emitter toward the light receiver is blocked in the document detection sensor 25B, and thus the document detection sensor 25B is in the light blocking state.

As illustrated in FIGS. 3, 4, and 8 to 10, the pickup unit 26 includes the pickup roller 26a for picking up the uppermost sheet of the document 3 placed on the document tray 23, the feed roller 26b for feeding the picked-up document 3 to the document reader 21 along the document conveyance path 27, the roller holder 26c for holding these rollers, and the like. The pickup unit 26 is driven by power transmitted from the document feeder body 2a via a power transmission mechanism 26d.

The pickup roller 26a is located at a standby position (see a solid line in FIG. 9) separated from the document tray 23 by a predetermined distance during the standby, and is controlled to move downward from the standby position to a contact position (see FIG. 10) where the pickup roller 26a comes into contact with the upper surface of the document 3 when a command of document reading is issued by the operation inputter 6 in a state where the document detection lever 25a detects that the document 3 is placed on the document tray 23.

The controller 5 causes the pickup unit 26 to execute an initial operation at a predetermined timing described later. The initial operation refers to an operation of moving the pickup unit 26 from a position close to the document tray 23 (see a two-dot chain line in FIG. 9) to a position separated from the document tray 23 by a predetermined distance (see a solid line in FIG. 9). As a result, when a document is placed on the document tray 23, a problem that it is difficult to place the document 3 because the pickup roller 26a of the pickup unit 26 is located at the contact position does not occur, for example.

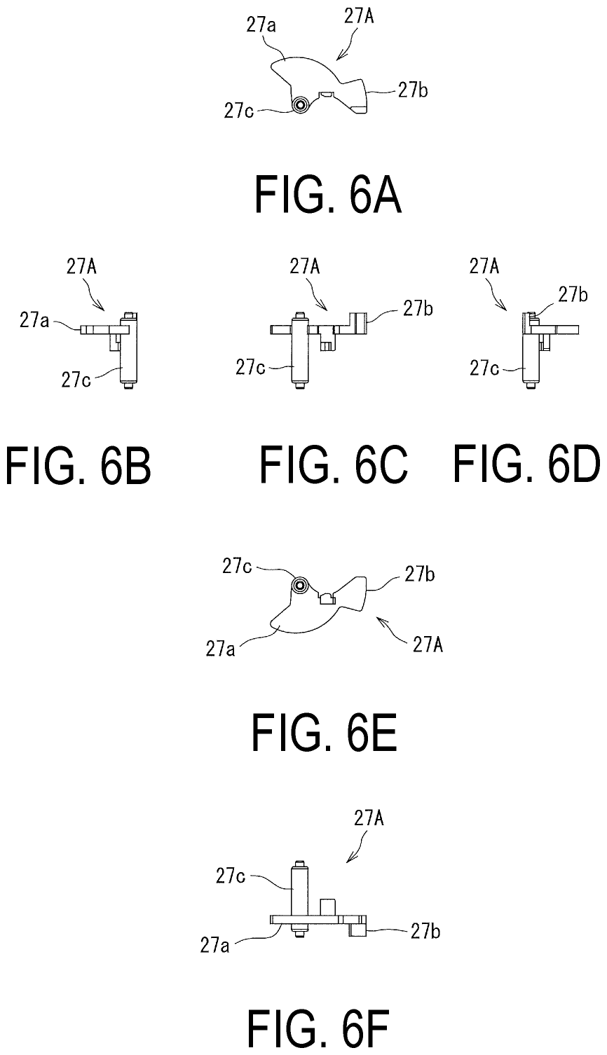

As illustrated in FIGS. 6A, 6B, 6C, 6D, 6E, and 6F, the detection body 27A is constituted of a detection piece 27a and a light blocking body 27b in such a manner that these components are integrally formed. The detection body 27A is pivotally supported to rotate about a detection-body rotation shaft 27c.

Since the detection body 27A is configured to detect the document 3 by coming into contact with the document 3 to be conveyed, the detection body 27A is provided within the width region of the document 3 in a direction orthogonal to the conveyance direction of the document 3.

When the leading end of the document 3 to be conveyed on the document conveyance path 27 comes into contact with the detection piece 27a, the detection body 27A rotates counterclockwise in FIGS. 10 and 13 about the detection-body rotation shaft 27c, and when the trailing end of the document 3 comes not to be in contact with the detection piece 27a, the detection body 27A rotates toward the original position by its own weight and stops.

The jam detection sensor 27B is also constituted of a transmission type photoelectric sensor including a light emitter and a light receiver. The detection body 27A is displaced to a light blocking position where light emitted from the light emitter toward the light receiver of the jam detection sensor 27B is blocked or to a light receiving position to make the emitted light received without being blocked while interlocking with the document 3 being conveyed.

That is, the detection body 27A is located at the light receiving position during being in contact with the document 3, and is located at the light blocking position when not in contact with the document 3. Therefore, the jam detection sensor 27B is in a light receiving state in which the emitted light is received when the detection body 27A is located at the light receiving position, and is in a light blocking state in which the emitted light is blocked when the detection body 27A is located at the light blocking position.

As described above, the rotation of the detection body 27A causes the light blocking body 27b to rotate, thereby turning on/off the jam detection sensor 27B (light is blocked or transmitted). As illustrated in FIGS. 10 and 13, when the document 3 is not in contact with the detection piece 27a, the light blocking body 27b of the detection body 27A is at a position where the jam detection sensor 27B is shielded from light; when the document 3 comes into contact with the detection piece 27a of the detection body 27A, the detection body 27A rotates counterclockwise, and the light blocking body 27b is located at a position where the jam detection sensor 27B is allowed to receive light.

During a normal document reading job, since the document 3 is conveyed at a predetermined conveyance speed, the jam detection sensor 27B is in the light blocking state until the document 3 approaches the jam detection sensor 27B by being conveyed. Then, the jam detection sensor 27B is brought into the light receiving state for a predetermined period of time during which the document 3 is conveyed, and returns to the light blocking state when the document 3 has passed through. When the conveyance of the document 3 is performed smoothly, no jam is detected (non-detection). On the other hand, when a jam occurs, since the document does not pass through the document conveyance path 27 and stays there, the light receiving state of the jam detection sensor 27B is continued. In such a case, the controller 5 detects the occurrence of the jam.

The controller 5 is configured to cause the document feeder 2 configured as described above to execute various judgment operations and various processes. Control performed by the controller 5 in the present embodiment will be described based on Table 1 given below.

TABLE 1

| | Jam | Document | | |
|---|---|---|---|---|
| | detection | detection | | |
| State | sensor | sensor | Judgment | Processing |
| Standby | Non- | Light | Access cover | — |
| | detection | receiving | opened/Access cover | |
| | | | closed, no document | |
| | | Light | Access cover closed, | — |
| | | blocking | document present | |
| Job being | Detection/ | Light | Access cover closed, | Reading job |
| executed | Non- | blocking | document present | continuation |
| | detection | Light | Access cover closed, | Reading job |
| | | receiving | no document | termination |
| Occurrence | Detection | — | Jam occurrence | Jam |
| of jam | | | | occurrence |
| | | | | notification |
| | Non- | — | Resolving Jam | Urging to |
| | detection | | | initial |
| | | | | operation |

When the image forming device 1 is in a standby state (a state in which the jam detection sensor 27B has not detected a jam of the document 3 and an execution operation of a reading job can be accepted), in a case where the document detection sensor 25B of the document placement detector 25 is in a light receiving state in which light emitted from the light emitter can be received by the light receiver, the controller 5 judges that the access cover 24 is opened as depicted in FIG. 11 or the access cover 24 is closed as depicted in FIG. 12, and judges that the document 3 is not placed on the document tray 23.

When the image forming device 1 is in the standby state, in a case where the document detection sensor 25B of the document placement detector 25 is in a light blocking state in which the light emitted from the light emitter toward the light receiver is blocked, the controller 5 judges that the access cover 24 is closed as depicted in FIG. 13 and the document 3 is placed on the document tray 23.

When the image forming device 1 is executing the reading job of the document 3, in a case where the document detection sensor 25B of the document placement detector 25 is in the light blocking state, the document 3 still remains in the document tray 23, and therefore the controller 5 continues the reading job. The jam detection sensor 27B repeats the light blocking state and the light receiving state every time the document 3 passes through the document conveyance path 27. In such a case, the controller 5 does not detect a jam.

When the image forming device 1 is executing the reading job of the document 3, in a case where the document detection sensor 25B of the document placement detector 25 is in the light receiving state (switched from the light blocking state to the light receiving state), no document 3 remains in the document tray 23, and therefore the controller 5 terminates the reading job. The jam detection sensor 27B repeats the light blocking state and the light receiving state every time the document 3 passes through the document conveyance path 27, and is brought into the light receiving state after the last sheet of the document 3 has passed through. In such a case, the controller 5 does not detect a jam.

On the other hand, when the image forming device 1 is executing the reading job of the document 3, in a case where a predetermined time has passed with the jam detection sensor 27B staying in the light receiving state (jam detection), it is considered that the document 3 is not appropriately conveyed and stays in the document conveyance path 27, and therefore the controller 5 judges that a jam has occurred.

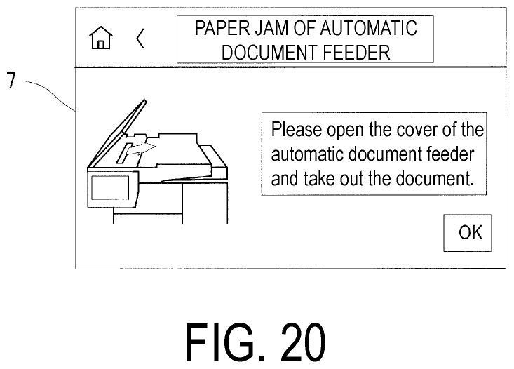

When it is judged that a jam has occurred, the controller 5 stops the reading job and notifies the occurrence of the jam. For example, as illustrated in FIG. 20, the notification is made by displaying a screen indicating a jam detection state on the display 7. In addition, at this time, a command to remove the document 3 from the document tray 23 may be issued. The notification may be made by blinking of a separately provided lamp or the like.

As depicted in FIG. 11, when it is judged that a jam has occurred, it is assumed that the document 3 is removed from the document tray 23 and the access cover 24 is opened to perform a jam resolving operation, and therefore the controller 5 may judge that the light receiving state of the document detection sensor 25B at this time corresponds to a state of the access cover 24 being opened.

When the jam detection sensor 27B is brought into the light blocking state (non-jam detection state) after the occurrence of the jam is notified, the controller 5 judges that the document 3 on the document conveyance path 27 has been removed and the jam has been resolved, and causes the user to confirm that the jam has been resolved on the display 7.

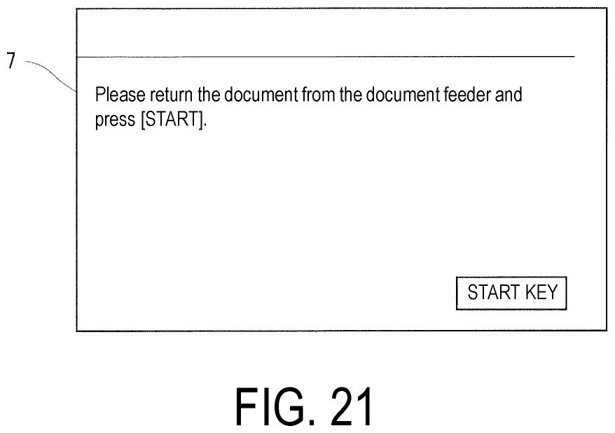

When the user operates the display 7 (presses the OK button depicted in FIG. 20), the controller 5 causes the pickup unit 26 to execute the initial operation and causes the display 7 to display a screen indicating a job restart state as depicted in FIG. 21.

When the document detection sensor 25B of the document placement detector 25 is in the light blocking state (switched from the light receiving state to the light blocking state), the controller 5 judges that the access cover 24 is closed as depicted in FIG. 13 and the document 3 is placed on the document tray 23, so that a state in which the execution operation of the reading job of the document 3 can be accepted (job restart state) is conducted.

That is, there are provided the operation inputter 6 and the jam detection sensor 27B to detect a jam of the document 3 conveyed on the document conveyance path 27. Further, in a case where the operation inputter 6 is operated after the jam detection sensor 27B is switched from a jam detection state in which a jam of the document 3 is detected to a non-jam detection state in which no jam is detected, the controller 5 switches the image forming device 1 from the jam detection state to the job restart state.

As discussed above, since the controller 5 can judge the state of the document feeder 2 based on signals from the document detection sensor 25B and the jam detection sensor 27B, and can control the document feeder 2, it is possible to omit a dedicated access detection scheme for detecting the access state of the access cover 24 as in the image forming device of the related art. This makes it possible to provide the image forming device 1 exhibiting advantageous effects in terms of the cost and space.

### Second Embodiment

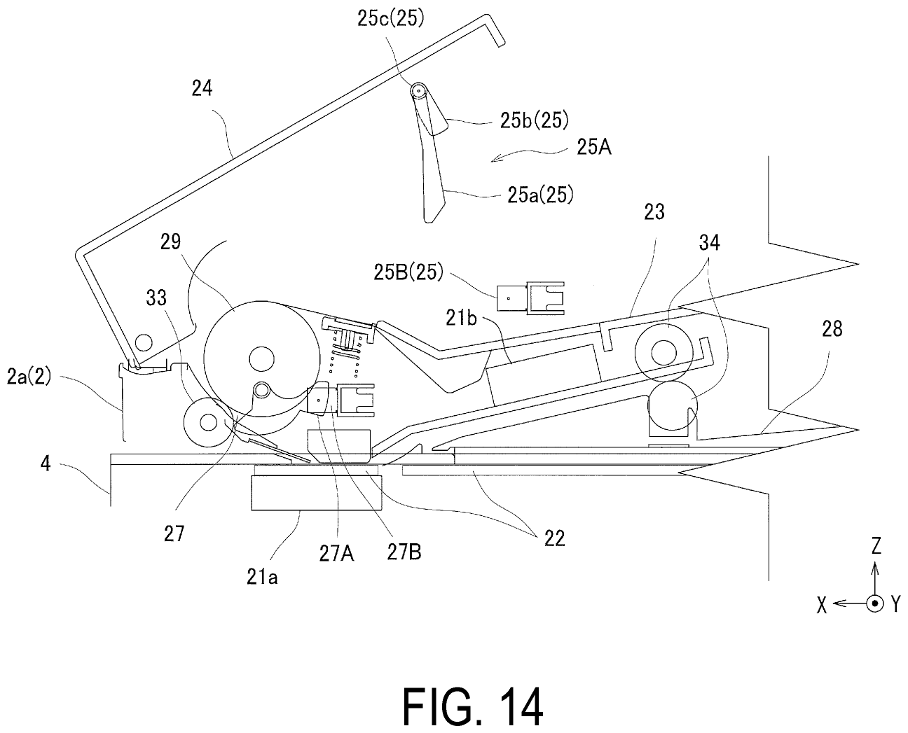

A second embodiment of the present disclosure will be described below with reference to the accompanying drawings, especially FIGS. 14, 15, and 16. Here, a configuration different from that of the first embodiment will be described, and the description discussed above is applied to the same configuration.

The first and second embodiments have a common configuration in the following point: like the document detection member 25A in the first embodiment, a document detection member 25A in the second embodiment also includes a document detection lever 25a, a light blocking body 25b, and a rotation shaft 25c connecting the document detection lever 25a and the light blocking body 25b in such a manner that these components are integrally formed. However, the second embodiment differs from the first embodiment in terms of an attachment angle of the light blocking body 25b relative to the rotation shaft 25c.

In the second embodiment, the control performed by a controller 5 based on a document detection sensor 25B, in which a light receiving state or a light blocking state is changed by a light blocking body 25b, is different from that in the first embodiment.

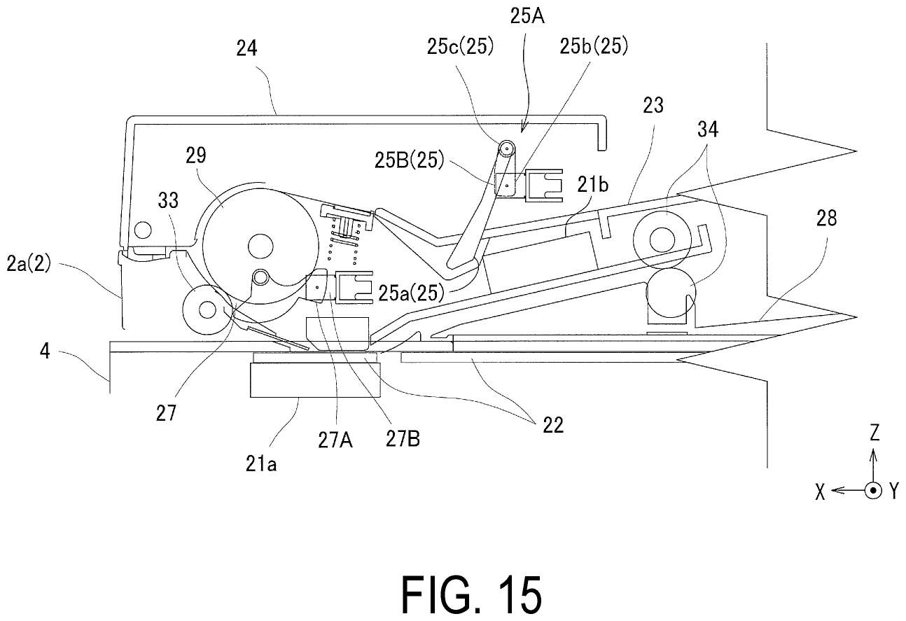

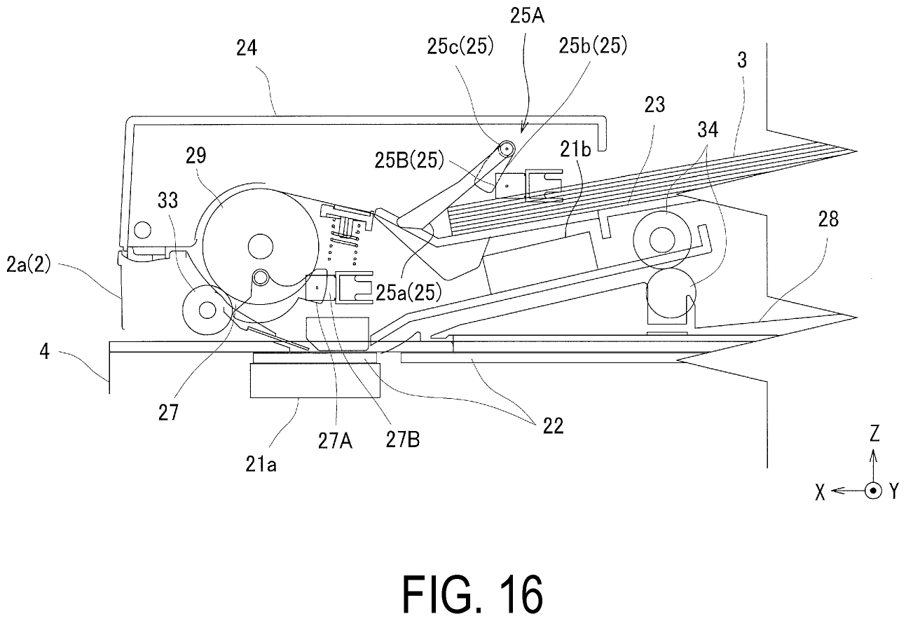

In the present embodiment, in a case where an access cover 24 is closed, the light blocking body 25b is located at a light blocking position when the document detection lever 25a is located at a detection standby position (see FIG. 15), and the light blocking body 25b is located at a light receiving position when the document detection lever 25a is located at a detection position (see FIG. 16).

Therefore, the document detection sensor 25B is in a light blocking state in which emitted light is blocked when the light blocking body 25b is at the light blocking position, and is in a light receiving state in which the emitted light is received when the light blocking body 25b is at the light receiving position.

That is, when a document 3 is not set, the document detection lever 25a is located at the detection standby position (see FIG. 15) because there is no document 3 in contact with the document detection lever 25a. At this time, since the light blocking body 25b is located at the light blocking position where light emitted from a light emitter toward a light receiver is blocked in the document detection sensor 25B, and thus the document detection sensor 25B is in the light blocking state.

When the document 3 is set, the document 3 is brought into contact with the document detection lever 25a, and thus the document detection lever 25a is located at the detection position (see FIG. 16). At this time, since the light blocking body 25b is located at the light receiving position to make it possible for the light emitted from the light emitter to be received by the light receiver in the document detection sensor 25B, the document detection sensor 25B is in the light receiving state.

The controller 5 is configured to cause a document feeder 2 configured as described above to execute various judgment operations and various processes. Control performed by the controller 5 in the present embodiment will be described based on Table 2 given below.

TABLE 2

| | Jam | Document | | |
|---|---|---|---|---|
| | detection | detection | | |
| State | sensor | sensor | Judgment | Processing |
| Standby | Non- | Light | Access cover | — |
| | detection | blocking | closed, | |
| | | Light | no document | — |
| | | receiving | Access cover | |
| | | | opened/Access | |
| | | | cover closed, | |
| | | | document present | |
| Job being | Detection/ | Light | Access cover closed, | Reading job |
| executed | Non- | receiving | document present | continuation |
| | detection | Light | Access cover closed, | Reading job |
| | | blocking | no document | termination |
| Occurrence | Detection | — | Jam occurrence | Jam |
| of jam | | | | occurrence |
| | | | | notification |
| | Non- | Light | Resolving Jam | Initial |
| | detection | receiving → | | operation |
| | | Light | | execution |
| | | blocking | | |

When an image forming device 1 is in a standby state (a state in which a jam detection sensor 27B has not detected a jam of the document 3 and an execution operation of a reading job can be accepted), in a case where the document detection sensor 25B of a document placement detector 25 is in the light blocking state, the controller 5 judges that the access cover 24 is closed as depicted in FIG. 15 and the document 3 is not placed on the document tray 23.

When the image forming device 1 is in the standby state, in a case where the document detection sensor 25B of the document placement detector 25 is in a light receiving state, the controller 5 judges that the access cover 24 is opened as depicted in FIG. 14, or judges that the access cover 24 is closed and the document 3 is placed on a document tray 23 as depicted in FIG. 16.

When the image forming device 1 is executing the reading job of the document 3, in a case where the document detection sensor 25B of the document placement detector 25 is in the light receiving state, the document 3 still remains in the document tray 23, and therefore the controller 5 continues the reading job. The jam detection sensor 27B repeats the light blocking state and the light receiving state every time the document 3 passes through a document conveyance path. In such a case, the controller 5 does not detect a jam.

When the image forming device 1 is executing the reading job of the document 3, in a case where the document detection sensor 25B of the document placement detector 25 is in the light blocking state (switched from the light receiving state to the light blocking state), no document 3 remains in the document tray 23, and therefore the controller 5 terminates the reading job. The jam detection sensor 27B repeats the light blocking state and the light receiving state every time the document 3 passes through the document conveyance path, and is brought into the light blocking state after the last sheet of the document 3 has passed through. In such a case, the controller 5 does not detect a jam.

On the other hand, when the image forming device 1 is executing the reading job of the document 3, in a case where a predetermined time has passed with the jam detection sensor 27B staying in the light receiving state (jam detection), it is considered that the document 3 is not appropriately conveyed and stays in a document conveyance path, and therefore the controller 5 judges that a jam has occurred.

When it is judged that a jam has occurred, the controller 5 stops the reading job and notifies the occurrence of the jam. For example, as illustrated in FIG. 20, the notification is made by displaying a screen indicating a jam detection state on the display 7. In addition, at this time, a command to remove the document 3 from the document tray 23 may be issued. The notification may be made by blinking of a separately provided lamp or the like.

As depicted in FIG. 14, when it is judged that a jam has occurred, it is assumed that the access cover 24 is opened and the document 3 is removed from the document tray 23 to perform a jam resolving operation, and therefore the controller 5 may judge that the light receiving state of the document detection sensor 25B at this time corresponds to the state of the access cover 24 being opened.

After the occurrence of the jam has been notified, when the jam detection sensor 27B is brought into the light blocking state (non-jam detection state), the controller 5 judges that the document 3 on a document conveyance path 27 has been removed and the jam has been resolved, or when the document detection sensor 25B is changed from the light receiving state to the light blocking state, the controller 5 judges that the access cover 24 is closed because the document 3 on the document conveyance path has been removed and the jam has been resolved. Then, the controller 5 causes the user to confirm that the jam has been resolved on the display 7. At this time, no document 3 is placed on the document tray 23.

When the user operates the display 7 (presses the OK button depicted in FIG. 20), the controller 5 causes the pickup unit 26 to execute the initial operation and causes the display 7 to display a screen indicating a job restart state as depicted in FIG. 21.

Thereafter, when the document detection sensor 25B of the document placement detector 25 is in the light receiving state (switched from the light blocking state to the light receiving state), the controller 5 judges that the access cover 24 is closed as depicted in FIG. 16 and the document 3 is placed on the document tray 23, so that a state in which the execution operation of the reading job of the document 3 can be accepted (job restart state) is conducted.

That is, there is provided the jam detection sensor 27B to detect a jam of the document 3 conveyed on the document conveyance path 27. Further, the controller 5 switches the image forming device 1 from the jam detection state to the job restart state when the following condition is satisfied: the jam detection sensor 27B is switched from a jam detection state in which a jam of the document 3 is detected to a non-jam detection state in which no jam is detected, and it is judged that the access cover 24 is closed and the document 3 is not placed on the document tray 23 at this time. Further, there is provided the display 7. The controller 5 switches the image forming device 1 from the jam detection state to the job restart state, and switches the display content of the display 7 from a screen indicating the jam detection state (see FIG. 20) to a screen indicating the job restart state (see FIG. 21).

As discussed above, since the controller 5 can judge the state of the document feeder 2 based on signals from the document detection sensor 25B and the jam detection sensor 27B, and can control the document feeder 2, it is possible to omit a dedicated access detection scheme for detecting the access state of the access cover 24 as in the image forming device of the related art. This makes it possible to provide the image forming device 1 exhibiting advantageous effects in terms of the cost and space.

### Third Embodiment

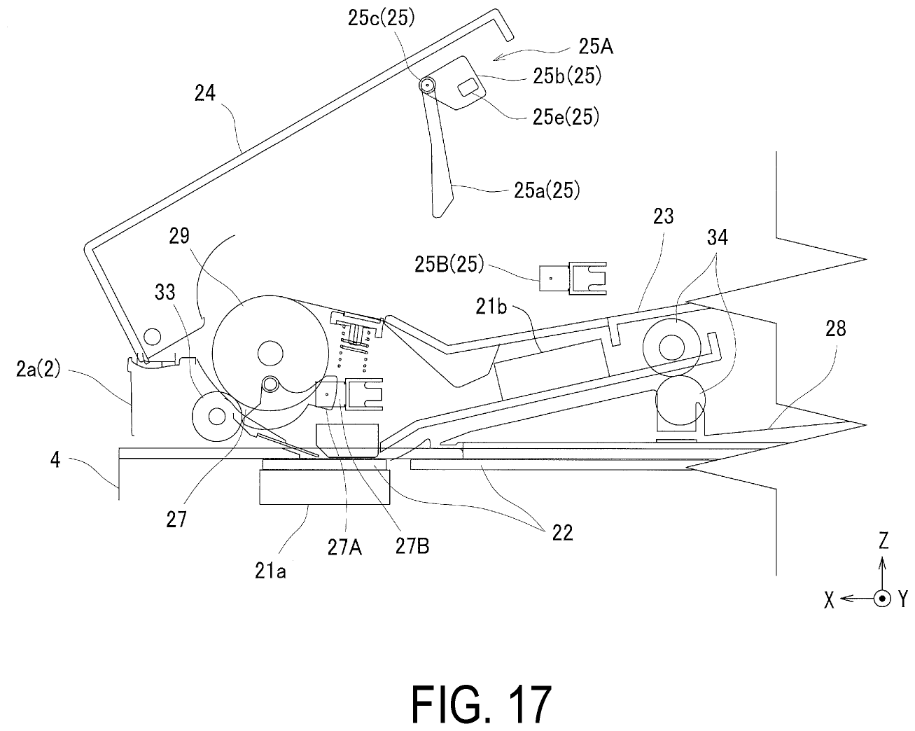

A third embodiment of the present disclosure will be described below with reference to the accompanying drawings, especially FIGS. 17, 18, and 19. Here, a configuration different from that of the first and second embodiments will be described, and the description discussed above is applied to the same configuration.

The third embodiment and the first embodiment have a common configuration in the following point: like the document detection member 25A in the first embodiment, a document detection member 25A in the third embodiment also includes a document detection lever 25a, a light blocking body 25b, and a rotation shaft 25c connecting the document detection lever 25a and the light blocking body 25b in such a manner that these components are integrally formed. However, the third embodiment differs from the first embodiment in that an attachment angle of the light blocking body 25b relative to the rotation shaft 25c is different, and that an opening 25e, through which light emitted from a light emitter can pass, is provided in the light blocking body 25b.

In the third embodiment, the control performed by a controller 5 based on a document detection sensor 25B, in which a light receiving state or a light blocking state is changed by a light blocking body 25b, is different from that in the first and second embodiments.

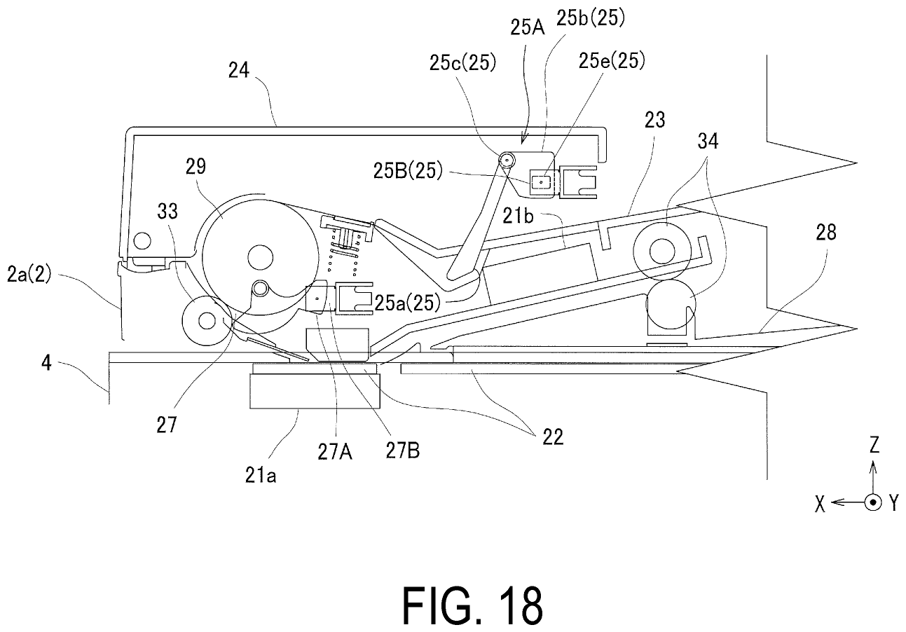

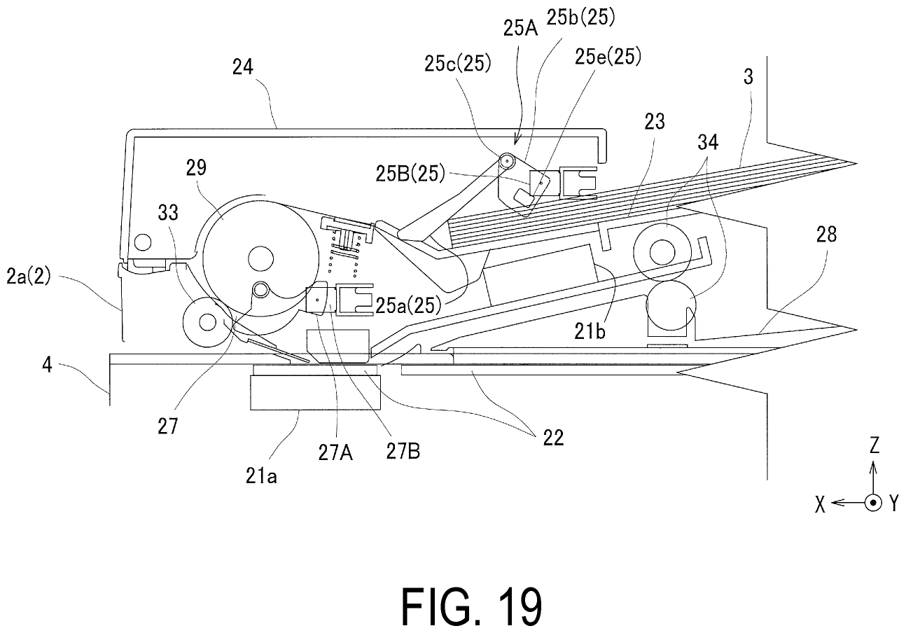

In the present embodiment, in a case where an access cover 24 is closed, the light blocking body 25b is located at a light receiving position to make it possible for the emitted light from the light emitter to be received by the light receiver via the opening 25e when the document detection lever 25a is located at a detection standby position (see FIG. 18), and the light blocking body 25b is located at a light blocking position when the document detection lever 25a is located at a detection position (see FIG. 19).

Therefore, the document detection sensor 25B is in a light receiving state in which the emitted light is received when the light blocking body 25b is at the light receiving position, and is in a light blocking state in which the emitted light is blocked when the light blocking body 25b is at the light blocking position.

That is, when a document 3 is not set, the document detection lever 25a is located at the detection standby position (see FIG. 18) because there is no document 3 in contact with the document detection lever 25a. At this time, since the light blocking body 25b is located at the light receiving position to make it possible for the light emitted from the light emitter to be received by the light receiver in the document detection sensor 25B, the document detection sensor 25B is in the light receiving state.

When the document 3 is set, the document 3 is brought into contact with the document detection lever 25a, and thus the document detection lever 25a is located at the detection position (see FIG. 19). At this time, since the light blocking body 25b is located at the light blocking position where the light emitted from the light emitter toward the light receiver is blocked in the document detection sensor 25B, and thus the document detection sensor 25B is in the light blocking state.

The controller 5 is configured to cause a document feeder 2 configured as described above to execute various judgment operations and various processes. Control performed by the controller 5 in the present embodiment will be described based on Table 3 given below.

TABLE 3

| | Jam | Document | | |
|---|---|---|---|---|
| | detection | detection | | |
| State | sensor | sensor | Judgment | Processing |
| Standby | Non- | Light | Access cover | — |
| | detection | receiving | opened/Access cover | |
| | | | closed, no document | |
| | | Light | Access cover closed, | — |
| | | blocking | document present | |
| | | Light | Access cover | Initial |
| | | blocking | opened/Access cover | operation |
| | | → Light | closed, no document | execution |
| | | receiving | | |
| Job being | Detection/ | Light | Access cover closed, | Reading job |
| executed | Non- | blocking | document present | continuation |
| | detection | Light | Access cover closed, | Reading job |
| | | receiving | no document | termination |
| Occurrence | Detection | — | Jam occurrence | Jam |
| of jam | | | | occurrence |
| | | | | notification |
| | Non- | Light | Jam resolved, | Initial |
| | detection | receiving | access cover | operation |
| | | → Light | closed, no | execution |
| | | blocking → | document | |
| | | Light | | |
| | | receiving | | |

When the image forming device 1 is in a standby state (a state in which a jam detection sensor 27B has not detected a jam of the document 3 and an execution operation of a reading job can be accepted), in a case where the document detection sensor 25B of a document placement detector 25 is in the light receiving state, the controller 5 judges that the access cover 24 is opened as depicted in FIG. 17 or judges that the access cover 24 is closed and the document 3 is not placed on the document tray 23 as depicted in FIG. 18.

When the image forming device 1 is in the standby state, in a case where the document detection sensor 25B of the document placement detector 25 is in the light blocking state, the controller 5 judges that the access cover 24 is closed and the document 3 is placed on the document tray 23 as depicted in FIG. 19.

When the image forming device 1 is in the standby state, in a case where the document detection sensor 25B of the document placement detector 25 is switched from the light blocking state to the light receiving state, the controller 5 judges that the access cover 24 is opened as depicted in FIG. 17 or the access cover 24 is closed with no document 3 placed on the document tray 23 as depicted in FIG. 18, and causes a pickup unit 26 to execute the initial operation.

When the image forming device 1 is executing the reading job of the document 3, in a case where the document detection sensor 25B of the document placement detector 25 is in the light blocking state, the document 3 still remains in the document tray 23, and therefore the controller 5 continues the reading job. The jam detection sensor 27B repeats the light blocking state and the light receiving state every time the document 3 passes through a document conveyance path. In such a case, the controller 5 does not detect a jam.

When the image forming device 1 is executing the reading job of the document 3, in a case where the document detection sensor 25B of the document placement detector 25 is in the light receiving state (switched from the light blocking state to the light receiving state), no document 3 remains in the document tray 23, and therefore the controller 5 terminates the reading job. The jam detection sensor 27B repeats the light blocking state and the light receiving state every time the document 3 passes through the document conveyance path, and is brought into the light receiving state after the last sheet of the document 3 has passed through. In such a case, the controller 5 does not detect a jam.

On the other hand, when the image forming device 1 is executing the reading job of the document 3, in a case where a predetermined time has passed with the jam detection sensor 27B staying in the light receiving state (jam detection), it is considered that the document 3 is not appropriately conveyed and stays in the document conveyance path 27, and therefore the controller 5 judges that a jam has occurred.

When it is judged that a jam has occurred, the controller 5 stops the reading job and notifies the occurrence of the jam. For example, as illustrated in FIG. 20, the notification is made by displaying a screen indicating a jam detection state on the display 7. In addition, at this time, a command to remove the document 3 from the document tray 23 may be issued. The notification may be made by blinking of a separately provided lamp or the like.

As depicted in FIG. 17, when it is judged that a jam has occurred, it is assumed that the document 3 is removed from the document tray 23 and the access cover 24 is opened to perform a jam resolving operation, and therefore the controller 5 may judge that the light receiving state of the document detection sensor 25B at this time corresponds to a state of the access cover 24 being opened.

After the occurrence of the jam has been notified, when the jam detection sensor 27B is brought into the light blocking state (non-jam detection state), the controller 5 judges that the document 3 on the document conveyance path has been removed and the jam has been resolved, or when the document detection sensor 25B is changed from the light receiving state to the light receiving state via the light blocking state, the controller 5 judges that the access cover 24 is closed because the document 3 on the document conveyance path has been removed and the jam has been resolved, and judges that the document 3 is not set. Then, the controller 5 causes the user to confirm that the jam has been resolved on the display 7.

When the user operates the display 7 (presses the OK button depicted in FIG. 20), the controller 5 causes the pickup unit 26 to execute the initial operation and causes the display 7 to display a screen indicating a job restart state as depicted in FIG. 21.

Thereafter, when the document detection sensor 25B of the document placement detector 25 is in the light blocking state (switched from the light receiving state to the light blocking state), the controller 5 judges that the access cover 24 is closed with the document 3 placed on the document tray 23 as depicted in FIG. 19, so that a state in which the execution operation of the reading job of the document 3 can be accepted (job restart state) is conducted.

That is, after the jam detection sensor 27B is switched from a jam detection state in which a jam of the document 3 is detected to a non-jam detection state in which no jam is detected, when the document detection sensor 25B is switched from the light receiving state to the light receiving state via the light blocking state, the image forming device 1 is switched from a jam detection state to a job restart state. Further, there is provided the display 7. The controller 5 switches the image forming device 1 from the jam detection state to the job restart state, and switches the display content of the display 7 from a screen indicating the jam detection state (see FIG. 20) to a screen indicating the job restart state (see FIG. 21).

As discussed above, since the controller 5 can judge the state of the document feeder 2 based on signals from the document detection sensor 25B and the jam detection sensor 27B, and can control the document feeder 2, it is possible to omit a dedicated access detection scheme for detecting the access state of the access cover 24 as in the image forming device of the related art. This makes it possible to provide the image forming device 1 exhibiting advantageous effects in terms of the cost and space.

A configuration disclosed in any of the embodiments described above can be applied in combination with a configuration disclosed in another embodiment as long as no contradiction arises. The embodiments disclosed in the present specification are merely examples, and the embodiments of the present disclosure are not limited thereto and can be appropriately modified within a range not departing from the object of the present disclosure.

What is claimed is:

1. An image forming device, comprising:
a document feeder including a document tray on which a document is placed, a document placement detector that detects the document placed on the document tray, and a pickup unit equipped with a pickup roller that feeds the document placed on the document tray to a downstream side of a document conveyance path; and
a controller that controls the document feeder, wherein
the document placement detector includes:
a document detection lever that is provided on an access cover provided in an openable and closable manner above the document tray, is located at a detection standby position for the document when the document is not placed on the document tray, and is displaced to a detection position for the document by being brought into contact with the document when the document is placed on the document tray; and
a document detection sensor that is provided in a main body of the document feeder and includes a light emitter and a light receiver,
the document detection lever is provided with a light blocking body to be displaced to a light blocking position where light emitted from the light emitter toward the light receiver of the document detection sensor is blocked or displaced to a light receiving position to make it possible for the emitted light to be received while interlocking with the displacement of the document detection lever,
the document detection sensor is set to be in a light blocking state in which the emitted light is blocked when the light blocking body is located at the light blocking position, and in a light receiving state in which the emitted light is received when the light blocking body is located at the light receiving position, and
the controller judges that, when the document detection sensor is in the light receiving state, the access cover is opened or the access cover is closed and the document is not placed on the document tray, and judges that, when the document detection sensor is in the light blocking state, the access cover is closed and the document is placed on the document tray.

2. The image forming device according to claim 1, further comprising:
a jam detection sensor that detects a jam of the document conveyed on the document conveyance path; and
an operation inputter, wherein
in a case where the operation inputter is operated after the jam detection sensor is switched from a jam detection state in which a jam of the document is detected to a non-jam detection state in which no jam is detected, the controller switches the image forming device from the jam detection state to a job restart state.

3. The image forming device according to claim 2, further comprising a display, wherein
the controller switches the image forming device from the jam detection state to the job restart state, and switches a display content of the display from a screen indicating the jam detection state to a screen indicating the job restart state.

4. The image forming device according to claim 2, wherein
the controller switches the image forming device from the jam detection state to the job restart state, and causes the pickup unit to execute an initial operation.

5. An image forming device, comprising:
a document feeder including a document tray on which a document is placed, a document placement detector that detects the document placed on the document tray, and a pickup unit equipped with a pickup roller that feeds the document placed on the document tray to a downstream side of a document conveyance path; and
a controller that controls the document feeder, wherein
the document placement detector includes:
a document detection lever that is provided on an access cover provided in an openable and closable manner above the document tray, is located at a detection standby position for the document when the document is not placed on the document tray, and is displaced to a detection position for the document by being brought into contact with the document when the document is placed on the document tray; and
a document detection sensor that is provided in a main body of the document feeder and includes a light emitter and a light receiver,
the document detection lever is provided with a light blocking body to be displaced to a light blocking position where light emitted from the light emitter toward the light receiver of the document detection sensor is blocked or displaced to a light receiving position to make it possible for the emitted light to be received while interlocking with the displacement of the document detection lever,
the document detection sensor is set to be in a light blocking state in which the emitted light is blocked when the light blocking body is located at the light blocking position, and in a light receiving state in which the emitted light is received when the light blocking body is located at the light receiving position, and
the controller judges that, when the document detection sensor is in the light blocking state, the access cover is closed and the document is not placed on the document tray, and judges that, when the document detection sensor is in the light receiving state, the access cover is opened or the access cover is closed and the document is placed on the document tray.

6. The image forming device according to claim 5, further comprising:
a jam detection sensor that detects a jam of the document conveyed on the document conveyance path, wherein
under a condition that in a case where the jam detection sensor is switched from a jam detection state in which a jam of the document is detected to a non-jam detection state in which no jam is detected, and it is judged that the document is not placed on the document tray when the access cover is closed, the controller switches the image forming device from the jam detection state to a job restart state.

7. The image forming device according to claim 6, further comprising a display, wherein
the controller switches the image forming device from the jam detection state to the job restart state, and switches a display content of the display from a screen indicating the jam detection state to a screen indicating the job restart state.

8. The image forming device according to claim 6, wherein
the controller switches the image forming device from the jam detection state to the job restart state, and causes the pickup unit to execute an initial operation.

9. An image forming device, comprising:
a document feeder including a document tray on which a document is placed, a document placement detector that detects the document placed on the document tray, and a pickup unit equipped with a pickup roller that feeds the document placed on the document tray to a downstream side of a document conveyance path; and
a controller that controls the document feeder, wherein
the image forming device further includes a jam detection sensor to detect a jam of the document conveyed on the document conveyance path,
the document placement detector includes:
a document detection lever that is provided on an access cover provided in an openable and closable manner above the document tray, is located at a detection standby position for the document when the document is not placed on the document tray, and is displaced to a detection position for the document by being brought into contact with the document when the document is placed on the document tray; and
a document detection sensor that is provided in a main body of the document feeder and includes a light emitter and a light receiver,
the document detection lever is provided with a light blocking body to be displaced to a light blocking position where light emitted from the light emitter toward the light receiver of the document detection sensor is blocked or displaced to a light receiving position to make it possible for the emitted light to be received while interlocking with the displacement of the document detection lever,
the document detection sensor is set to be in a light blocking state in which the emitted light is blocked when the light blocking body is located at the light blocking position, and in a light receiving state in which the emitted light is received when the light blocking body is located at the light receiving position,
the controller judges that, when the document detection sensor is in the light receiving state, the access cover is opened or the access cover is closed and the document is not placed on the document tray, and judges that, when the document detection sensor is in the light blocking state, the access cover is closed and the document is placed on the document tray, and
after the jam detection sensor is switched from a jam detection state in which a jam of the document is detected to a non-jam detection state in which no jam is detected, in a case where the document detection sensor is switched from the light receiving state to the light receiving state via the light blocking state, the controller switches the image forming device from the jam detection state to a job restart state.

10. The image forming device according to claim 9, further comprising a display, wherein
the controller switches the image forming device from the jam detection state to the job restart state, and switches a display content of the display from a screen indicating the jam detection state to a screen indicating the job restart state.

11. The image forming device according to claim 10, wherein
the controller switches the image forming device from the jam detection state to the job restart state, and causes the pickup unit to execute an initial operation.
